(19) United States
(12) Patent Application Publication
(10) Pub. No.: US 2025/0245671 A1
(43) Pub. Date: Jul. 31, 2025

(54) SYSTEMS AND METHODS FOR DYNAMICALLY ROUTING CUSTOMER REQUEST TO VARIOUS REPRESENTATIVES

(71) Applicant: Walmart Apollo, LLC, Bentonville, AR (US)

(72) Inventors: Dinesh Sardana, Wilton, CT (US); Murali Ramanathan, Bangalore (IN); Israel Roybal Ramos, Springdale, AR (US); Tyler Andrew Crosson, Fayetteville, AR (US); Michael James Ellis, Nashville, TN (US); Russell Anderson Wilkins, Jr., Rogers, AR (US); Joseph Glenn Davis, Columbia, SC (US); Kirsten Marie Zeimen, Novi, MI (US); Aswin Mohan Geethadevi Das, Fremont, CA (US); Ayush Bhardwaj, New Delhi (IN); Elisha Eugene Kemmet, Pea Ridge, AR (US)

(21) Appl. No.: 18/423,809

(22) Filed: Jan. 26, 2024

(51) Int. Cl. G06Q 30/015; G06Q 10/0631; H04M 3/523

(52) U.S. Cl. CPC G06Q 30/015; G06Q 10/063112; H04M 3/5232

(57) ABSTRACT

Systems and methods for dynamically routing a customer request to various representatives are disclosed. In some embodiments, a disclosed method includes: obtaining, from a customer, a request for service from an entity; obtaining context information of the request; selecting, from a set of representatives associated with the entity, a dynamic target group of representatives based on the context information and a predetermined set of criteria; and routing the request simultaneously to agent devices associated with the dynamic target group of representatives.

### TECHNICAL FIELD

This application relates generally to request routing and, more particularly, to systems and methods for dynamically routing a customer request to various representatives.

### BACKGROUND

A customer often wants to reach a representative of an entity to resolve a question or concern regarding a product or service provided by the entity. Typically, the customer is required to identify an appropriate telephone number to call, navigate and remember a number of options, and wait on hold until a live representative is available to answer the customer's call.

A call handling system is an automated system designed to interact with callers by gathering required information and routing the calls to a particular recipient without the help of a human assistant. The current call handling system for delivering phone calls is based on a statically defined group of phones. In addition, the current call handling system rings all agents in a fixed pool or department without determining: who is working today, who is not on break, who has moved to a different department, or a device is handed to a new agent. This will introduce potential issues with overloaded associates, incorrect routing, and missed calls.

### SUMMARY

The embodiments described herein are directed to systems and methods for dynamically routing a customer request to various representatives.

In various embodiments, a system including a non-transitory memory configured to store instructions thereon and at least one processor is disclosed. The at least one processor is operatively coupled to the non-transitory memory and configured to read the instructions to: obtain, from a customer, a request for service from an entity; obtain context information of the request; select, from a set of representatives associated with the entity, a dynamic target group of representatives based on the context information and a predetermined set of criteria; and route the request simultaneously to agent devices associated with the dynamic target group of representatives.

In various embodiments, a computer-implemented method is disclosed. The computer-implemented method includes: obtaining, from a customer, a request for service from an entity; obtaining context information of the request; selecting, from a set of representatives associated with the entity, a dynamic target group of representatives based on the context information and a predetermined set of criteria; and routing the request simultaneously to agent devices associated with the dynamic target group of representatives.

In various embodiments, a non-transitory computer readable medium having instructions stored thereon is disclosed. The instructions, when executed by at least one processor, cause at least one device to perform operations including: obtaining, from a customer, a request for service from an entity; obtaining context information of the request; selecting, from a set of representatives associated with the entity, a dynamic target group of representatives based on the context information and a predetermined set of criteria; and routing the request simultaneously to agent devices associated with the dynamic target group of representatives.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for dynamically routing a customer request to various representatives, in accordance with some embodiments of the present teaching;

FIG. 2 is a block diagram of a routing center server, in accordance with some embodiments of the present teaching;

FIG. 3 is a block diagram illustrating various portions of a system for dynamically routing a customer request to various representatives, in accordance with some embodiments of the present teaching;

FIG. 4 is a block diagram illustrating various portions of a data center server, in accordance with some embodiments of the present teaching;

FIG. 5 is a block diagram illustrating various portions of a routing center server, in accordance with some embodiments of the present teaching;

FIG. 6 illustrates exemplary components in a data feeding system, in accordance with some embodiments of the present teaching;

FIG. 7 illustrates exemplary data used for dynamically routing a customer request, in accordance with some embodiments of the present teaching;

FIG. 8 is a flowchart illustrating an exemplary method for dynamically routing a customer request to various representatives, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

An entity, e.g. a retailer selling products, typically uses an automated call handling system to handle and route phone calls from customers. While most automated call handling systems are designed for a fixed group of agents, the present teaching discloses methods and systems for handling and routing a customer request to a dynamic group of representatives.

In some embodiments, an end-to-end control system is disclosed for handling phone calls from customers, and delivering the phone calls to associates on their marked mobile devices, e.g. through an application installed on the mobile devices. In addition, the system can work in tandem with the wired phone lines using any call management technology, e.g. an interactive voice response (IVR) system.

In some embodiments, by injecting a call routing module in the path after establishing session initiation protocol (SIP) connectivity, the system will determine the best-suited associates to answer the call based on their availability status, workload, and relevant skills. In some embodiments, a routing engine in the system manages ad-hoc work patterns of associates and maintains states of available associates to ensure that no associate is overloaded. In addition, the routing engine can build important skill attributes for the associates to capture the qualities that are required for matching the customer contact with the best available associates.

In some examples, a customer call is routed through IVR, a routing engine and distributed to one or many representative endpoints including but not limited to: wired phones, mobile phones, a contact center voice queue, a contact center video call queue, a conversational or AI based IVR, or a pre-recorded message. In some examples, a customer chat is sent to the routing engine to be distributed to a series of representative endpoints including but not limited to: live agent chat queues or chatbots, based on either a statically set workflow or an AI application. In some examples, a customer request from a web based application is sent to the routing engine to be distributed to a representative endpoint including but not limited to: a video call representative, a voice call contact center representative, a voice call representative at a retail location, a conversational or AI based IVR, a pre-recorded message, a directive for an in-person assistance, a live agent chat, or a chatbot, based on either a statically set workflow or an AI application. In some examples, a customer request from an email is sent to the routing engine to be distributed to a representative endpoint including but not limited to: a live agent queue for response or an automated response engine, based on either a statically set workflow or an AI application. In all of these examples, the representative endpoints may include both on-premise endpoints and cloud-based endpoints.

As such, the disclosed system can ensure a smooth voice communication established between a customer and a set of associates best suited to take the call. The set of associates may be dynamically selected based on intelligent routing. The system can ring simultaneously multiple mobile and wired phones of the best available associates.

The disclosed system brings novel features, including an ability to distribute voice calls and contacts in parallel across a range of different devices, including e.g. wired IP phones, wired analog phones, smart mobile phones, desktop devices, chatbots, etc. The system also allows for integration with any application that can provide associate states and can manage their workload and priorities for any ad-hoc work where a contact needs to be delivered to the associate. The system can be integrated with any bot or artificial intelligence (AI) for self-service, and can use any telecommunication carrier to optimize cost and speed. Additionally, the system tracks which agent has accepted the voice call, making it easier to coordinate and manage contact with multiple associates.

In some embodiments, once an agent has answered the call, the system will stop calling all other agents or representatives. In some embodiments, a static set of endpoints can be used for distributing a voice call to multiple parties at the same time.

Furthermore, in the following, various embodiments are described with respect to systems and methods for dynamically routing a customer request to various representatives are disclosed. In some embodiments, a disclosed method includes: obtaining, from a customer, a request for service from an entity; obtaining context information of the request; selecting, from a set of representatives associated with the entity, a dynamic target group of representatives based on the context information and a predetermined set of criteria; and routing the request simultaneously to agent devices associated with the dynamic target group of representatives.

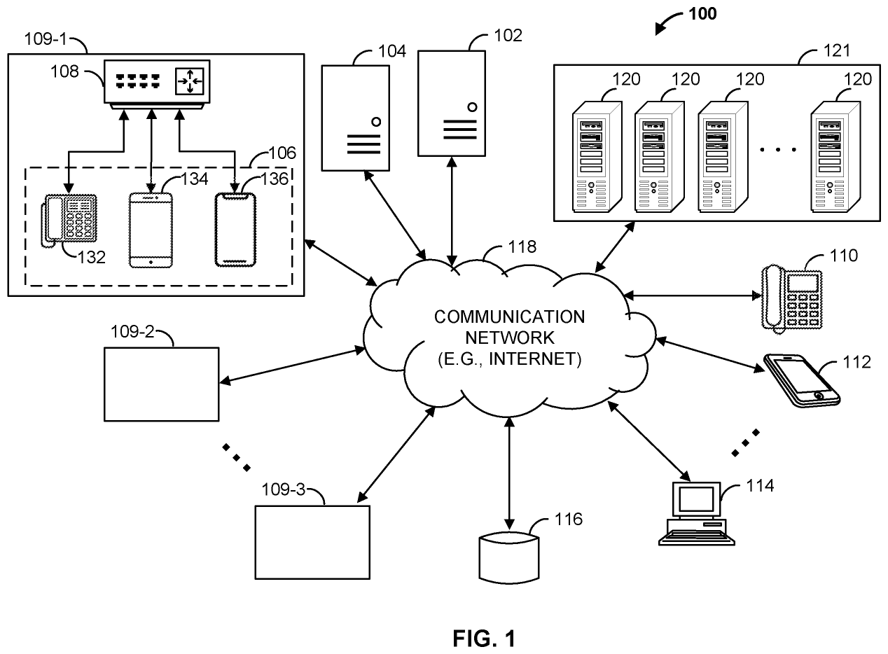

Turning to the drawings, FIG. 1 is a network environment 100 configured for dynamically routing a customer request to various representatives, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a routing center server 102, a data center server 104, a cloud-based engine 121 including one or more processing devices 120, a database 116, agent devices 106, and one or more customer computing devices 110, 112, 114 operatively coupled over the network 118. The routing center server 102, the data center server 104, the agent devices 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the routing center server 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the routing center server 102.

In some examples, each of the multiple customer computing devices 110, 112, 114 can be a wired phone, cellular phone, a smart phone, a tablet, a personal assistant device, a voice assistant device, a digital assistant, a laptop, a computer, or any other suitable device. In some examples, the routing center server 102, the processing devices 120, and/or the data center server 104 are operated by a retailer, and the multiple customer computing devices 110, 112, 114 are operated by customers of the retailer. In some examples, the processing devices 120 are operated by a third party (e.g., a cloud-computing provider).

The agent devices 106 are operably coupled to the communication network 118 via a router (or switch) 108. The agent devices 106 and/or the router 108 may be located at or associated with a store or department 109-1 of a retailer, for example. At the same time, the retailer may also include other stores or departments 109-2, 109-3, each of which is also associated with one or more agent devices similarly to the store or department 109-1. The agent devices 106 can communicate with the routing center server 102 and/or the data center server 104 over the communication network 118. The routing center server 102 and/or the data center server 104 can route a contact request, e.g. a call, from one of the customer computing devices 110, 112, 114 to one or more of the agent devices 106.

Although FIG. 1 illustrates three customer computing devices 110, 112, 114, the network environment 100 can include any number of customer computing devices 110, 112, 114. Similarly, the network environment 100 can include any number of the routing center servers 102, the processing devices 120, the data center servers 104, the agent devices 106, the stores or departments 109, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, any of the first customer computing device 110, the second customer computing device 112, and the Nth customer computing device 114 may communicate with the data center server 104 over the communication network 118. For example, a customer uses one of the multiple customer computing devices 110, 112, 114 to contact or call an entity, e.g. a retailer selling products, to request for a service about one of the products. The call is first received by the data center server 104. The data center server 104 can use a menu driven system, e.g. an interactive voice response (IVR) system, to interact with the customer and collect inputs from the customer. In some embodiments, the data center server 104 can use a dual tone multi frequency (DTMF) system or a voice enabled system to recognize the intent of the customer and collect inputs from the customer.

In some examples, the IVR system may connect the customer with a wired phone of an agent, e.g. based on the inputs of the customer. For example, the IVR system may connect the customer with the wired phone 132 in the department 109-1, as the inputs from the customer indicates a question related to the department 109-1.

In some examples, the IVR system forwards the request to the routing center server 102. The request may be forwarded to the routing center server 102 standalone or together with input data of the customer. In some examples, the routing center server 102 determines context information of the request, e.g. based on the input data of the customer; and selects, from a set of representatives associated with the entity, a dynamic target group of representatives based on the context information and a predetermined set of criteria. The routing center server 102 then routes the request simultaneously to agent devices associated with the dynamic target group of representatives. In one example, the routing center server 102 can route the request to the mobile devices 134, 136 simultaneously. In another example, the routing center server 102 can route the request to the mobile device 134 and the wired phone 132 simultaneously. In yet another example, the routing center server 102 can route simultaneously the request to mobile devices and/or wired phones in different stores or departments of the entity.

In some examples, the routing center server 102 may execute one or more models (e.g., programs or algorithms), such as a machine learning model, deep learning model, statistical model, etc., to determine where to route a request. The routing center server 102 may route the request, carried by a call, a text message, an email or an online chat, to target agent devices 106 in one or more stores or departments 109 over the communication network 118. A communication will be established between the customer and one or more of the target agent devices 106.

The routing center server 102 is further operable to communicate with the database 116 over the communication network 118. For example, the routing center server 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the routing center server 102, in some examples, the database 116 can be a local storage device, such as a hard drive, a non-volatile memory, or a USB stick. The routing center server 102 may store user and location data related to different representatives in the database 116. The routing center server 102 may receive store related data from different stores 109 and store them as store data in the database 116. The routing center server 102 may also generate and store routing related models and data in the database 116.

In some examples, the routing center server 102 generates and/or updates different models for dynamically routing a customer request to various representatives. The models, when executed by the routing center server 102, allow the routing center server 102 to determine which agent(s) to select and route the request.

In some examples, the routing center server 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the routing center server 102 may select a target group of representatives and route the request to them.

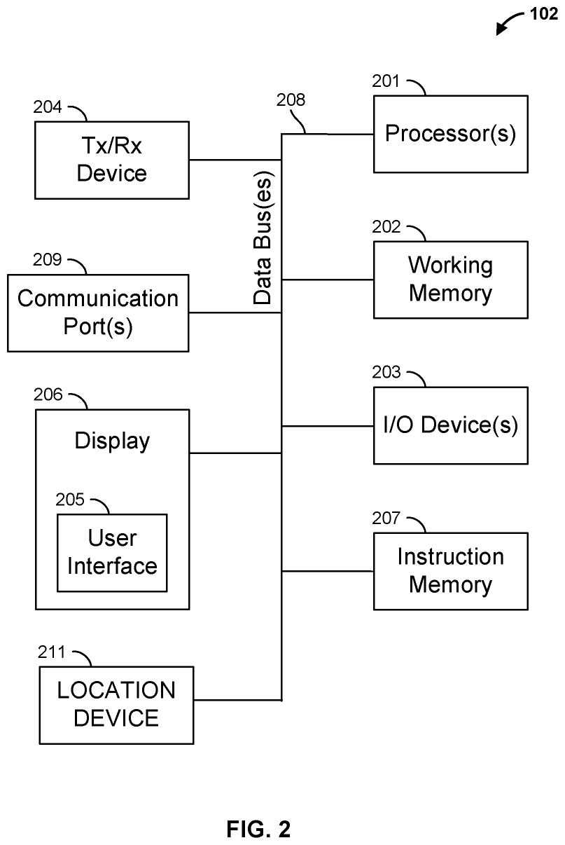

FIG. 2 illustrates a block diagram of a routing center server, e.g. the routing center server 102 of FIG. 1, in accordance with some embodiments of the present teaching. In some embodiments, each of the routing center server 102, the data center server 104, the customer computing devices 110, 112, 114, the agent devices 132, 134, 136, and the one or more processing devices 120 in FIG. 1 may include the features shown in FIG. 2. Although FIG. 2 is described with respect to certain components shown therein, it will be appreciated that the elements of the routing center server 102 can be combined, omitted, and/or replicated. In addition, it will be appreciated that additional elements other than those illustrated in FIG. 2 can be added to the routing center server 102.

As shown in FIG. 2, the routing center server 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the routing center server 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the routing center server 102 can include a single memory unit configured to operate as both instruction memory and working memory. Further, although embodiments are discussed herein including non-volatile memory, it will be appreciated that the routing center server 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the routing center server 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the routing center server 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the routing center server 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11 a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the routing center server 102 and/or the data center server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the routing center server 102 may determine a local geographical area (e.g., town, city, state, etc.) of its position.

In some embodiments, the routing center server 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

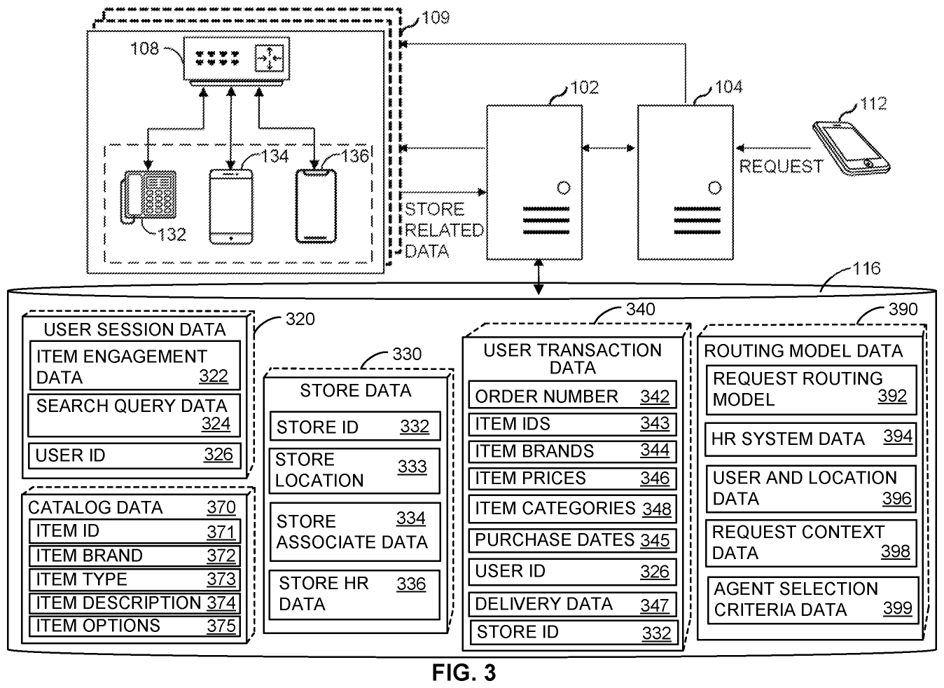

FIG. 3 is a block diagram illustrating various portions of a system for dynamically routing a customer request to various representatives, e.g. the system shown in the network environment 100 of FIG. 1, in accordance with some embodiments of the present teaching.

In some embodiments, a customer may operate one of the customer computing devices 110, 112, 114 to initiate a web browser that is directed to a website of the retailer. The customer may, via the web browser, view and click on item advertisements for items displayed on the website. The website may also allow the customer to add one or more of the items to an online shopping cart, and allow the customer to perform a “checkout” of the shopping cart to purchase the items. A server hosting the website may capture these activities as user session data 320, and transmit the user session data 320 to the routing center server 102 over the communication network 118. The routing center server 102 may store the user session data 320 in the database 116. In some examples, the user session data 320 may include item engagement data 322, search query data 324, and user ID 326 (e.g., a customer ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search query data 324 may identify one or more searches conducted by a user during a browsing session (e.g., a current browsing session).

The routing center server 102 may also receive store related data from the stores (or departments) 109, which identifies and characterizes one or more in-store purchases. In some embodiments, the store related data may also indicate other information about the stores 109. The routing center server 102 may parse the store related data to generate store data 330. In this example, the store data 330 may include, for each store, one or more of: a store ID 332 of the store, a store location 333 of the store, a store associate data 334 indicating data for each associate working in or at the store, and a store human resource (HR) data 336 identifying and charactering HR related data associated with the store.

The routing center server 102 may also receive online purchase data from the website server, which identifies and characterizes one or more online purchases, such as purchases made by the customer and other customers via the retailer's website. In some embodiments, the routing center server 102 may parse the store related data and the online purchase data to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (e.g., category) of each item purchased, purchase dates 345 identifying the purchase dates of the purchase orders, a user ID 326 for the user making the corresponding purchase, delivery data 347 indicating delivery information for corresponding online orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store routing model data 390 identifying and characterizing one or more routing models and related data. For example, the routing model data 390 may include a request routing model 392, an HR system data 394, a user and location data 396, a request context data 398, and an agent selection criteria data 399. The request routing model 392 may be used to determine where to route a request. For example, the request routing model 392 is used to determine which agents or agent devices should be selected for routing an incoming call. In some embodiments, the request routing model 392 is a machine learning model trained based on historical request routing data.

The HR system data 394 may be used, e.g. by the routing center server 102, to determine work related status and skills of each associate or agent of the retailer. For example, the HR system data 394 includes data related to: availability status of each representative to support a request; information of a store or department associated with each representative; job code of each representative; clock status of each representative; leave status of each representative; language preference of each representative; and a skill profile of each representative. In some embodiments, the HR system data 394 includes more than HR data associated with an entity. For example, the HR system data 394 may include a contact center vendor's onboarding agents who will work as agents or supervisors. In some embodiments, the HR system data 394 is generated offline and updated periodically. In some embodiments, the HR system data 394 is generated at run time or real-time after a request is received. In some embodiments, some of the HR system data 394 is generated offline and updated periodically; and the other of the HR system data 394 is generated at run time after a request is received.

The user and location data 396 may include user data and location data for a predetermined set of representatives associated with an entity. In some embodiments, the predetermined set of representatives may include: an internal set of associates of the entity, a third party workforce associated with the entity, an expert associated with the entity, and a self-service application or a chatbot associated with the entity. In some embodiments, the user and location data 396 is generated by the routing center server 102 based on historical HR system data 394, and is updated when the HR system data 394 is updated.

The request context data 398 may be generated to include context information of an incoming request from a customer. The request context data 398 may be used, e.g. by the routing center server 102, to select a target group of representatives to route the request. In some examples, the request context data 398 is utilized together with the request routing model 392 at run time after the request is received, to route the request. In some examples, the request context data 398 includes at least one of: account information of the customer; information input by the customer regarding the request; historical requests of the customer; historical services provided to the customer by the entity; historical feedbacks of the customer regarding the historical requests or the historical services; topic category data of the request; or language used by the customer.

The agent selection criteria data 399 includes data of a set of criteria to be used for agent selection. In some embodiments, the agent selection criteria data 399 is generated based on the HR system data 394. In some embodiments, each criterion in the agent selection criteria data 399 is related to a condition on a status or skill in the HR system data 394. For example, one criterion is that each selected agent must be available according to the availability status, the clock status, and/or the leave status of the agent. For example, another criterion is that each selected agent must have a language preference matching the language spoken by the customer. For example, another criterion is that each selected agent must have a matching score regarding the request higher than a threshold. In some embodiments, the matching score is determined based on the context information of the request, information of a store or department associated with the agent, a job code describing a main job description of the agent, and a skill profile of the agent.

In the example shown in FIG. 3, the data center server 104 receives a request from a customer computing device 112. The request may be received in form of: a phone call, an in-person request, a text message, an email, a voice call, a video call, an online chat, or a service application. In some examples, the request is regarding a product sold by a retailer hosting the routing center server 102 and the data center server 104. In response, the data center server 104 may first collect inputs from the customer, e.g. based on a menu driven system. In some embodiments, based on the inputs, the data center server 104 directly routes the request to one or more wired phones in the stores 109. In some embodiments, based on the inputs, the data center server 104 forwards the request to the routing center server 102. The routing center server 102 then selects a target group of representatives from a set of representatives based on context information of the request and a predetermined set of criteria, and route the request simultaneously to agent devices associated with the target group of representatives.

In some embodiments, the agent devices comprise at least one mobile device and at least one wired phone. In some embodiments, the routing center server 102 routes the request to the at least one mobile device via an application server hosting an application pre-installed on the at least one mobile device. In some embodiments, the routing center server 102 routes the request to the at least one wired phone via the data center server 104. In some embodiments, the context information of the request may be determined based on the inputs of the customer, account information of the customer, and/or historical request context data 398 related to the customer. In some embodiments, the predetermined set of criteria may be obtained from the agent selection criteria data 399.

In some embodiments, the routing center server 102 may assign one or more of the above described operations to a different processing unit or virtual machine hosted by the one or more processing devices 120. Once one of the target agent devices is answered by an agent, a communication is established between the customer and the agent to address the request. In some embodiments, the communication can be established between the customer and multiple representatives at the same time. In some embodiments, a call may be forwarded to a different department. In some examples, an associate can answer a call on a mobile device and forward the call to another department within the store or can dial a number, e.g. an extension. In some examples, an associate can make a call back to the customer.

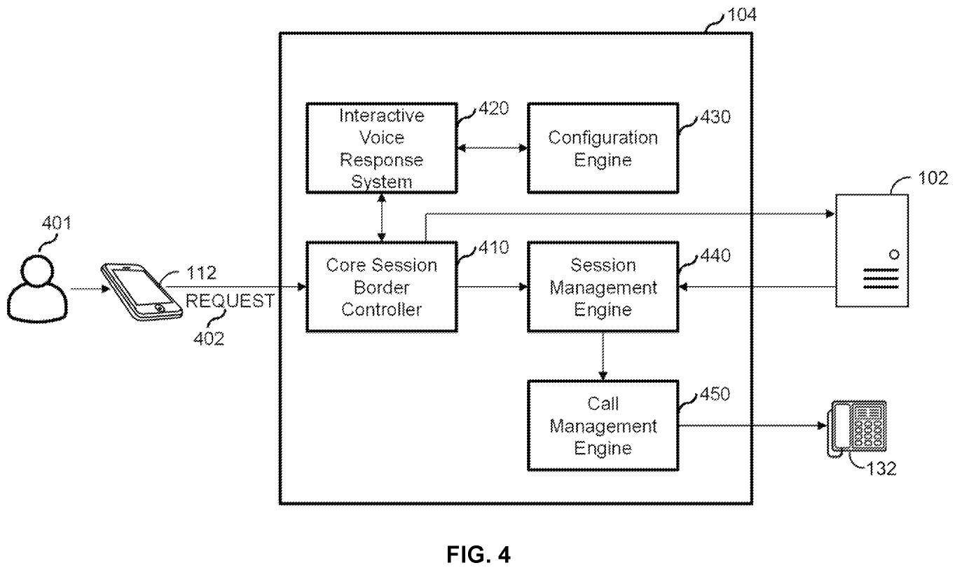

FIG. 4 is a block diagram illustrating various portions of a data center server, e.g. the data center server 104 in FIG. 1, in accordance with some embodiments of the present teaching. As shown in FIG. 4, the data center server 104 in this example includes a core session border controller (SBC) 410, an interactive voice response (IVR) system 420, a configuration engine 430, a session management engine 440, and a call management engine 450. In some examples, one or more of the core SBC 410, the IVR system 420, the configuration engine 430, the session management engine 440, and the call management engine 450 are implemented in hardware. In some examples, one or more of the core SBC 410, the IVR system 420, the configuration engine 430, the session management engine 440, and the call management engine 450 are implemented as an executable program maintained in a tangible, non-transitory memory, such as the instruction memory 207 of FIG. 2, which may be executed by one or processors, such as the processor 201 of FIG. 2.

For example, the core SBC 410 may obtain a request 402 sent by a user 401 via the customer computing device 112. In the example shown in FIG. 4, the request 402 is a phone call made by the user 401 using customer computing device 112. In other examples, the request 402 can be in form of an email, an in-person request, a text message, a voice call, a video call, an online chat, or a service application request, with similar operations of the data center server 104 and the routing center server 102. In some embodiments, the request 402 is seeking a service from an entity, e.g. a retailer, associated with the routing center server 102 and the data center server 104. For example, the user 401 may be a customer of the retailer and have some questions about a product sold by the retailer.

In some embodiments, the core SBC 410 secures voice over IP (VoIP) infrastructures while providing interworking between incompatible signaling messages and media flows or sessions. In some embodiments, the core SBC 410 is configured to manage session initiation protocol (SIP) channels and control communication from the customer computing device 112. In one example, the customer computing device 112 is calling a number of the entity through a mobile network operator, which directs the call to the data center server 104. The core SBC 410 can pick up the call and acknowledge the mobile network operator that the entity is in the call and the mobile network operator can release media resources accordingly.

The core SBC 410 can route the call to the IVR system 420, which is a menu driven system that can interact with the customer by reading some prompts, identify certain verbal words or phrases from the customer, and provide a flow for directing the call. In some embodiments, there are multiple IVR systems 420 in the data center server 104, e.g. each of the IVR systems 420 corresponding to a different store or department. The core SBC 410 can determine which IVR system to coordinate with based on the calling number. In some embodiments, the configuration engine 430 can provide a dynamic set of configurations for the prompts designed for the IVR system 420.

After the IVR system 420 determines, based on input or selection of the customer, a topic category of the request, the IVR system 420 determines a store or department the customer wants to talk to based on the topic category. Then, the IVR system 420 forwards back the request to the core SBC 410 with an identification of the determined store or department. The core SBC 410 then routes the call to the session management engine 440, which manages sessions in SIP channels.

In some embodiments, the session management engine 440 is configured to route the call to the call management engine 450 with the identification of the determined store or department. The call management engine 450 has pre-registered various wired devices or wired phones under different stores or departments of the entity. For example, based on a store ID routed with the call, the call management engine 450 can identify a set of wired phones registered in association with the store ID, and determine a subset of the wired phones that are active at the moment. As such, the call management engine 450 will send a signal to ring the active wired phone(s) associated with the store ID. In the example shown in FIG. 4, the call management engine 450 routes the call to the wired phone 132.

In some embodiments, the core SBC 410 is also configured to route the call to the routing center server 102, trying to connect the customer to one or more mobile devices through the routing center server 102. In some embodiments, the routing center server 102 routes back the call to the session management engine 440, e.g. after determining that no available agent that is registered with a mobile device and has a skill set matching the request can pick up the call at the moment.

In some embodiments, the core SBC 410 routes the call both to the routing center server 102 and to the session management engine 440. In some embodiments, the core SBC 410 routes the call to the routing center server 102 first, and the session management engine 440 will receive the call from the routing center server 102 if there is no available mobile device based agent is found. In some embodiments, the core SBC 410 only routes the call to the routing center server 102, and the routing center server 102 will determine whether to route the call to a wired phone through the session management engine 440, to a mobile phone, or both. In some embodiments, the data center server 104 in FIG. 4 may have a different structure or include different components, without impacting the structure and operation of the routing center server 102 or other devices in the system.

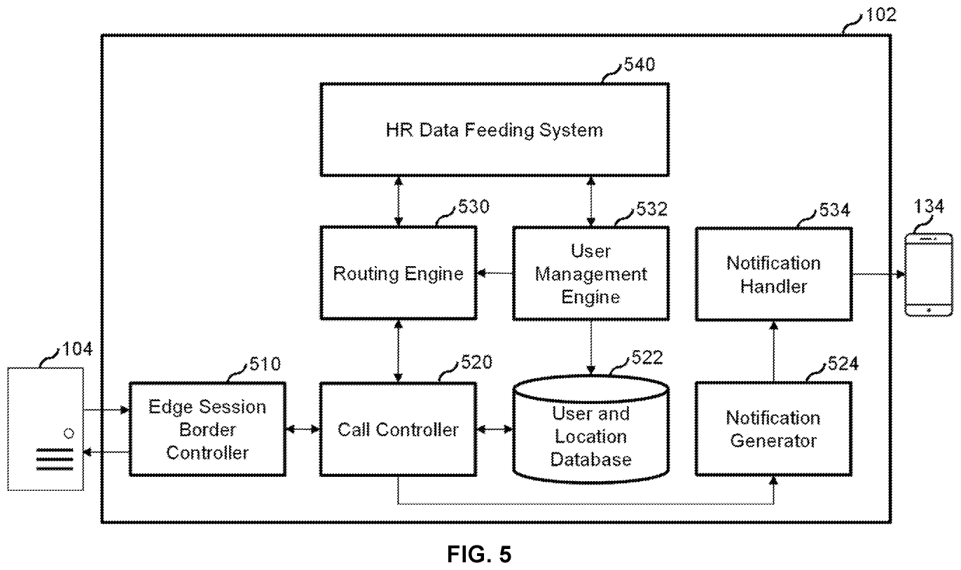

FIG. 5 is a block diagram illustrating various portions of a routing center server, e.g. the routing center server 102 in FIG. 1, in accordance with some embodiments of the present teaching. As shown in FIG. 5, the routing center server 102 in this example includes an edge session border controller (SBC) 510, a call controller 520, a user and location database 522, a notification generator 524, a routing engine 530, a user management engine 532, a notification handler 534, and an HR data feeding system 540. In some examples, one or more of the edge SBC 510, the call controller 520, the notification generator 524, the routing engine 530, the user management engine 532, the notification handler 534, and the HR data feeding system 540 are implemented in hardware. In some examples, one or more of the edge SBC 510, the call controller 520, the notification generator 524, the routing engine 530, the user management engine 532, the notification handler 534, and the HR data feeding system 540 are implemented as an executable program maintained in a tangible, non-transitory memory, such as the instruction memory 207 of FIG. 2, which may be executed by one or processors, such as the processor 201 of FIG. 2.

In some examples, the edge SBC 510 receives a request sent by the data center server 104. For example, the request may be the same as the request 402 carried by the call from the customer computing device 112. In some examples, the edge SBC 510 receives context information of the request from the data center server 104 together with the request. For example, the context information comprises at least one of: account information of the customer; information input by the customer regarding the request; historical requests of the customer; historical services provided to the customer by the entity; historical feedbacks of the customer regarding the historical requests or the historical services; topic category data of the request; or language used by the customer. In some embodiments, the edge SBC 510 receives part of the context information, e.g. account information of the customer and inputs of the customer, and the rest of the context information will be determined by the routing engine 530.

In some embodiments, the edge SBC 510 is configured to host rules and configurations for routing the call traffic. For example, the edge SBC 510 can route the call to the call controller 520, which controls a call based on a service application for web conferencing, video conferencing, voice conferencing, softphone and contact center.

In some embodiments, the call controller 520 asks the routing engine 530 to determine who should be called for the incoming call based on the context information collected from the call menu and/or a database, e.g. the database 116. In some embodiments, the routing engine 530 selects dynamically, from a set of representatives associated with the entity, a target group of representatives based on the context information and a predetermined set of criteria. In some embodiments, the set of representatives comprises: an internal set of associates of the entity; a third party workforce associated with the entity; an expert associated with the entity; and a self-service application or a chatbot associated with the entity. In some embodiments, the predetermined set of criteria comprises criteria related to status and skill data of each representative, including at least one of: availability status of each representative to support the request; information of a store or department associated with each representative; job code of each representative; clock status of each representative; leave status of each representative; language preference of each representative; or a skill profile of each representative. In some embodiments, the skill profile can include multiple attributes in different categories that can be assigned to a representative. In some embodiments, the skill profile of an associate includes a Quality of Service (QoS) score, which is computed based on ratings of the calls the associate answered before. The ratings may be from a supervisor and/or customers, and may be associated with a particular skill.

In some embodiments, the routing engine 530 obtains the criteria data (e.g. conditions and thresholds) from a database, e.g. the database 116. In some embodiments, the routing engine 530 obtains the status and skill data from the HR data feeding system 540 synchronously at run time after the call is received. In some embodiments, the routing engine 530 obtains the status and skill data from the user management engine 532 asynchronously, which can occur before the call comes in. In some embodiments, the routing engine 530 obtains some of the status and skill data from the HR data feeding system 540 synchronously, and obtains some of the status and skill data from the user management engine 532 asynchronously. In some embodiments, the routing engine 530 at run time is transparent of where the status and skill data comes from. For example, the status and skill data may come from a HR database, vendor call center locations adding users, third party vendors from marketplace adding their agents, or a pre-sale company providing a toll free phone number.

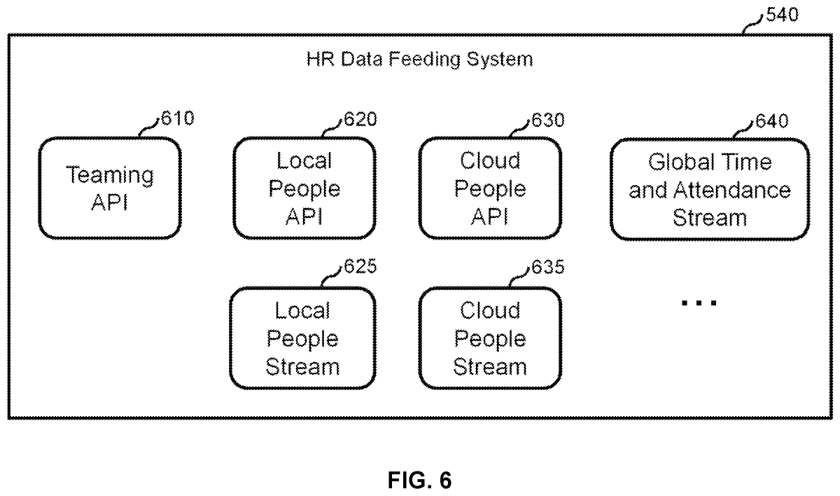

The HR data feeding system 540 is a system configured to feed HR data of the entity. In some embodiments, the HR data feeding system 540 can feed some HR data to the routing engine 530 synchronously at run time; and feed some HR data to the user management engine 532 asynchronously. FIG. 6 illustrates exemplary components in a data feeding system, e.g. the HR data feeding system 540 in FIG. 5, in accordance with some embodiments of the present teaching.

As shown in FIG. 6, the HR data feeding system 540 in this example includes: a teaming application programming interface (API) 610, a local people API 620, a local people stream 625, a cloud people API 630, a cloud people stream 635, and a global time and attendance stream 640. In some embodiments, the teaming API 610 is an API for feeding data related to teams in the entity. Each team includes a group of people having a common set of tasks or a common set of skills. A same person may work in one team on one day, and work in another team on another day.

In some embodiments, the local people API 620 includes one or more API's on top of local databases in the entity. Upon a query, e.g. from the routing engine 530 or the user management engine 532, the local people API 620 will pull data related to people and their work from the local databases. Similarly, the cloud people API 630 includes one or more API's on top of cloud databases. Upon a query, e.g. from the routing engine 530 or the user management engine 532, the cloud people API 630 will pull data related to people and their work from the cloud databases. For example, the data pulled by the local people API 620 and the cloud people API 630 may include core profile information for an associate, information about a user profile, etc.

In some embodiments, the local people stream 625 is a parallel system to the local people API 620, and can automatically pull data related to people and their work from local databases in the entity and push the data, e.g. to the routing engine 530 or the user management engine 532. Similarly, the cloud people stream 635 is a parallel system to the cloud people API 630, and can automatically pull data related to people and their work from cloud databases and push the data, e.g. to the routing engine 530 or the user management engine 532. For example, the data pulled by the local people stream 625 and the cloud people stream 635 may include incremental changes for an associate, any change happening to a user profile, etc.

In some embodiments, the global time and attendance stream 640 is a stream service that can automatically track and make data available, e.g. to the routing engine 530 or the user management engine 532, about time and attendance status of any agent. For example, the global time and attendance stream 640 can track whether an associate is plugged in or plugged out on a given store, whether an associated is clock in or clock out, or any change happening to the clock status of an associate or agent. The global time and attendance stream 640 can report streams of these kinds of events automatically.

In some embodiments, a database associated with any of the teaming API 610, the local people API 620, the local people stream 625, the cloud people API 630, the cloud people stream 635 and the global time and attendance stream 640 can be part of the database 116, or a standalone database. In some embodiments, the teaming API 610 reports data to the routing engine 530 synchronously at run time; and the local people API 620, the local people stream 625, the cloud people API 630, the cloud people stream 635 and the global time and attendance stream 640 report or send data to the user management engine 532 asynchronously.

Referring back to FIG. 5, with the API's and streams, the HR data feeding system 540 can track real-time updates from HR systems for the associates, to ensure an informed routing consultation request from the routing engine 530 or the user management engine 532. For example, the user management engine 532 can collect data related to HR profile, associate skills, associate clock status, associate leave status, associate engagement, etc., from the local people API 620, the local people stream 625, the cloud people API 630, the cloud people stream 635 and/or the global time and attendance stream 640 asynchronously. The user management engine 532 maintains these data and sends them a cache of the routing engine 530 asynchronously. As such, these data will be easily accessible at run time.

In some embodiments, the asynchronous operations by the user management engine 532 and some components in the HR data feeding system 540 are performed periodically. In some embodiments, the asynchronous operations by the user management engine 532 and some components in the HR data feeding system 540 are performed based on events, i.e. following an event driven mechanism. For example, after an agent logged in, the user management engine 532 pushes that information to the routing engine 530 such that it is available at run time.

In some examples, a new associate is hired by the entity. Then, corresponding information about the new associate is sent from the HR system, e.g. by the local people API 620 or the cloud people API 630, to the user management engine 532. The user management engine 532 can determine that the new associate will be an agent to answer phone calls for customer service; and send the HR information for the new associate to the user and location database 522 to provision a new account for the new associate. In some embodiments, the user management engine 532 generates the new account for the new associate and stores the new account to the user and location database 522. In some embodiments, the new account is an account associated with a web conferencing, video conferencing, voice conferencing, softphone, phone call, voice call, or any other application that can be installed on a mobile device of the new associate. With the new account, an incoming call can be routed to the application on the mobile device of the new associate.

In some embodiments, the user and location database 522 stores a list of users that can serve as representatives for answering customer service calls. Each user in the list has an account stored in the user and location database 522. In some embodiments, the user and location database 522 stores other account information for each of the list of users, e.g. location, department, HR profile, clock status, etc. In some embodiments, the user and location database 522 can be part of the database 116, or a standalone database. In some embodiments, a user or an associate is tied to a department, but the location of the associate is not static. For example, the system can track the associate in any corner of the store based on a store mapping and utilizing the associate's agent device and Wi-Fi signal to find where the associate is.

In some embodiments, the call controller 520 can retrieve the list of agent accounts from the user and location database 522 asynchronously, such that the call controller 520 knows immediately which account is associated with which agent at run time after a call is received. In some embodiments, after selecting the target group of representatives, the routing engine 530 instructs the call controller 520 to route the request simultaneously to all agent devices associated with the target group of representatives. In some embodiments, the agent devices associated with the target group of representatives comprise at least one mobile device and at least one wired phone. In some embodiments, an agent in the target group has both a mobile device and a wired phone, which are both called by the call controller 520 for the request.

In some embodiments, the call controller 520 can identify the accounts for the target group of representatives, and instruct the notification generator 524 to generate a notification for each account. The notification handler 534 is configured to control sending each notification to a corresponding agent device. In the example shown in FIG. 5, a notification is sent to a mobile device 134 of an associate.

In some embodiments, each representative's mobile device pre-registered with the routing center server 102 has a target application installed thereon. In some embodiments, each notification is sent by the notification handler 534, via an application server hosting the target application, to a corresponding mobile device associated with a corresponding agent. In some embodiments, a script to guide a conversation between the customer and the corresponding agent is dynamically generated at run time for the corresponding agent and displayed on the target application. In some embodiments, one or more suggested tools are provided to the corresponding agent via the target application to support the request. In some embodiments, the application server ensures a standardized notification delivery to associate mobile devices. In some embodiments, the request is enriched after being routed through the call controller 520 and the notification generator 524, to ensure the request complies to the mobile ecosystem.

As discussed above, in some embodiments, e.g. when no target agent is found based on the criteria by the routing engine 530, the call controller 520 forwards back the request to the data center server 104 via the edge SBC 510, e.g. to the session management engine 440 in the data center server 104, to route the request to some wired phone(s). In some embodiments, all phones and devices, wired or mobile, are all registered to the routing center server 102 for answering customer calls. As such, some of the target representatives may use wired phones, while some of the target representatives may use mobile devices. Accordingly, the call controller 520 routes the call simultaneously to the wired phones via the data center server 104, and to the mobile devices via the notification generator 524 and the notification handler 534. As such, the incoming call is routed to an ad-hoc and dispersed workforce holding various devices to support the customer request.

In some embodiments, the routing center server 102, e.g. via the notification handler 534 and/or the application server, can determine that one of the target agent devices is answered before the remaining target agent devices. Once that happens, the routing center server 102 stops calling or ringing the remaining target agent devices.

In some embodiments, the routing center server 102 allows two or more of the target agent devices be answered, and enables the two or more of the target agent devices to communicate with the customer synchronously and simultaneously to address the request.

In some embodiments, the entity is a retailer. In one example, the request is submitted by the customer when the customer is located in a store associated with the retailer. For example, the request is submitted by the in-store customer either in person or via an application associated with the retailer. In this example, associates working in the store are given priority during the selection of the target group of representatives by the routing engine 530. In some embodiments, in accordance with a determination that no associate working in the store is available to assist the customer with the request, a call is established between the customer and a remote agent. In some examples, the remote agent is one of: an associate working in other stores of the retailer, an associate employed by the retailer, an agent of a supplier of the retailer, an agent of a vendor of the retailer, a delivery driver for the retailer, an expert on a product related to the request, a self-service application or a chatbot associated with the retailer.

In some embodiments, after receiving a customer request or demand, the disclosed system provisions a target of associates from workforce to support this request, distributes the task to the associates according to a business related workflow. In some embodiments, the target group of associates is not necessarily known until run time. In some embodiments, the target group of associates is not necessarily setup to support customer calls or chats prior to the request being received. In some embodiments, the target group at time TO is not necessarily the same group of associates at time T1. In some embodiments, the target group is defined by a predetermined set of criteria and skills. In some embodiments, the target application to deliver the task to the associates is flexible and can change over time. In some embodiments, the source application to allow the customer to make a request is flexible and can change over time. In some embodiments, the target group does not need training to support the request as resources for support are dynamically generated at run time.

In some embodiments, a customer calls into a store of a retailer. The call is routed to a specific group of associates on mobile devices to support various topics. In some embodiments, the associates are provided with a softphone application to have access to answer the customer call. The softphone application can be changed over time.

In some embodiments, customer calls are categorized by topic, e.g. based on inputs of the customers; and are routed to associates based on associates' availability status supporting other requests, store number, job code, clock status, leave status, language preference, and primary job task, etc. The call category and job code mappings can be defined and maintained by the system. A script to guide the conversation may be dynamically generated at run time for an associate and displayed on an application installed on a mobile device of the associate. Some suggested tools to support the request can be provided to the associate at run time as well.

In some examples, a customer calls a phone line of a store to talk to someone in the electronics department for checking store availability of a smartphone and is a native Spanish speaker. In this example, the system routes the call to a mobile phone of an associate who is available and working in the electronics department, even if the associate's primary job task is not related to answering calls.

In some examples, another customer calls a store to inquire about ingredients in a beauty product sold in the store and is an English speaker. In this example, the system routes out the call to mobile devices or wired phones associated with a third party organization, which can be a producer or designer of the beauty product.

In some embodiments, a contact is received by a contact center of the retailer, via email, chat or voice. The contact is routed to an associate agent or bot agent to address the request, by the disclosed system. Based on the context of the request, the target group of representatives can be selected by a routing engine, e.g. the routing engine 530, in the disclosed system. The target group may be an internal set of associate, a third party workforce, an expert, a self-service application or a chatbot.

In some embodiments, a customer visiting a store of a retailer needs assistance in the store. Rather than finding an associate in person by the customer, the customer can send a request via a source application associated with the retailer. The source application may be installed on a mobile device of the customer. After receiving the assistance request, the routing engine in the disclosed system can match the context of the assistance request with associate data to find the right retail associate in the store to assist the customer. As such, all of the methods and systems discussed before about skill based associate selection can be expanded to in person requests in a store. The nearest associate is not necessarily chosen, and the associate selection will be based on skill set, ability to assist, availability to assist, language matching, etc. as discussed before. In some examples, if no associate in the store is available to assist the customer, the target group can be expanded to a remote expert, such that a video conference is established between this remote or third party expert and the customer to answer product questions for the customer.

In one example, a customer starts a chat through a kiosk or QR code within a store to inquire about a computer product; and the system routes the pre-sale chat externally to a designing team of the computer product. In another example, a customer starts a chat through a kiosk or QR code within a store to inquire about a smartphone product; and the system routes the chat internally to an agent in the store.

While a typical interaction is between two parties in either synchronous mode or asynchronous mode, the system also supports conversations where more than two parties are communicating synchronously. These conversations can happen between: retailer associates, customers, retailer call center agents/supervisors, vendors/suppliers' call center agents, delivery drivers, vendors, producers, etc.

The disclosed system provides a multi-tenant platform designed to contextually identify the right associate(s) or agent(s) to support customers' requests across all communication channels. This agent selection accounts for real-time data changes to meet business, legal, and skill-based requirements. The system controls the volume and velocity of ad-hoc requests routed to associates, including voice calls and in-store customer requests.

In some embodiments, this platform can also support contact center routing and pre-sales support to connect customers and associates beyond stores. The system includes a routing engine designed to define dynamic attributes that make up a profile for an associate, agent, driver or external company. This profile is matched at runtime to the highest priority mapped skill. The incoming contact introduces a set of attributes that apply to that contact and will be used to find the right associate based on profiles and skills of the associates.

In some embodiments, the run time inputs to the routing engine includes: customer phone number, store number, call context, call category. In some embodiments, the run time inputs to the routing engine further includes attributes derived from the customer: e.g. customer sentiment, customer personality, customer value, etc. These attributes may be derived based on the customer's historical transaction, communication and/or interaction data with the retailer, using some machine learning model.

In some embodiments, the run time outputs of the routing engine includes: a target group of associates, and/or a final associate selection. In some embodiments, the asynchronous inputs to the routing engine includes: an associate clock status; associate language; call context to associate criteria mapping; associate pay type; associate identifiers: e.g. name, email address, employment ID, user ID; associate primary store; associate job code; associate leave status.

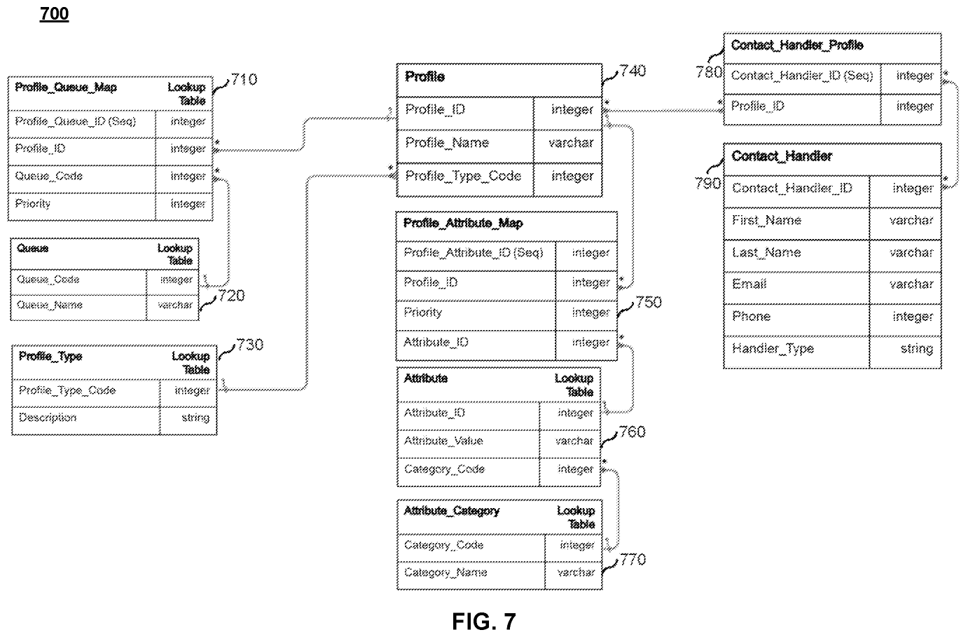

FIG. 7 illustrates exemplary data in a database 700 used for dynamically routing a customer request, in accordance with some embodiments of the present teaching. In some embodiments, the database 700 is in a cache of a routing engine, e.g. the routing engine 530 in FIG. 5. In some embodiments, the database 700 is part of the database 116, or a standalone database.

As shown in FIG. 7, the database 700 includes: a Profile Queue Map table 710, a Queue table 720, a Profile Type table 730, a Profile table 740, a Profile Attribute Map table 750, an Attribute table 760, an Attribute Category table 770, a Contact Handler Profile table 780, and a Contact Handler table 790. These tables are cross indexed to each other as shown in FIG. 7. For example, a category in the Attribute Category table 770 indicates a customer type or a skill set, and is cross indexed to the Attribute table 760 to be associated with an attribute indicating a value for a profile of a customer or associate. A queue code in the Queue table 720 indicates a skill set of an associate. A priority in the Profile Queue Map table 710 indicates different priority levels for different skills of an associate. Each associate has a contact handler ID in the Contact Handler Profile table 780 and the Contact Handler table 790, and has a profile ID stored in the Profile table 740, the Profile Attribute Map table 750 and the Contact Handler Profile table 780.

As such, all of the profile data, skill data, customer data, and associate data can be mapped to each other. The structure in the database 700 can help the routing engine to quickly determine a target list of associates best matching a request at run time, such that the call will be routed to mobile or wired phones of these associates. In some embodiments, the database 700 includes more tables, or multiple versions of each table for different stores or departments.

In some embodiments, the system has multiple layers to realize the dynamic agent selection and routing. In some examples, the system includes a policy server layer to decide the target list of associates or third party support groups to address customer request. In some examples, the system includes a workflow engine layer to monitor the status of each individual request based on a timed escalation path to redirect requests to associates based on availability. In some examples, the system includes a user manager layer to collect all user data updates from source HR systems, e.g. updates related to employment status, job codes, clock status, language, etc. In some examples, the system includes a notification layer to relay the request payload to the associate or third party application to display the customer request. In some examples, the system includes a configuration layer to collect all business defined criteria, e.g. call context to associate criteria mapping, contact directory, etc.

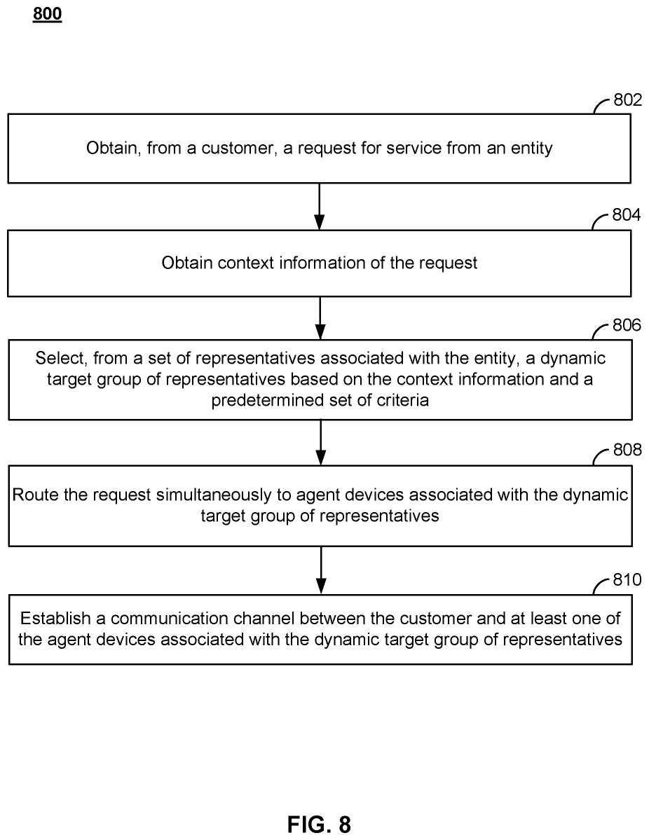

FIG. 8 is a flowchart illustrating an exemplary method 800 for dynamically routing a customer request to various representatives, in accordance with some embodiments of the present teaching. In some embodiments, the method 800 can be carried out by one or more computing devices, such as the routing center server 102, the data center server 104 and/or the cloud-based engine 121 of FIG. 1. Beginning at operation 802, a request for service from an entity is obtained from a customer. At operation 804, context information of the request is obtained. At operation 806, a dynamic target group of representatives is selected from a set of representatives associated with the entity, based on the context information and a predetermined set of criteria. At operation 808, the request is routed simultaneously to agent devices associated with the dynamic target group of representatives. At operation 810, a communication channel is established between the customer and at least one of the agent devices associated with the dynamic target group of representatives.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain, from a customer, a request for service from an entity,
obtain context information of the request,
select, from a set of representatives associated with the entity, a dynamic target group of representatives based on the context information and a predetermined set of criteria, and
route the request simultaneously to agent devices associated with the dynamic target group of representatives.

2. The system of claim 1, wherein the request is obtained in form of:
a phone call, an in-person request, a text message, an email, a voice call, a video call, an online chat, or a service application.

3. The system of claim 1, wherein the at least one processor is configured to read the instructions to:
determine that one of the agent devices is answered before the remaining agent devices; and
stop calling the remaining agent devices once the one agent device is answered.

4. The system of claim 1, wherein the at least one processor is configured to read the instructions to:
determine that two or more of the agent devices are answered; and
enable the two or more of the agent devices to communicate with the customer synchronously and simultaneously regarding the request.

5. The system of claim 1, wherein the context information comprises at least one of:
account information of the customer;
information input by the customer regarding the request;
historical requests of the customer;
historical services provided to the customer by the entity;
historical feedbacks of the customer regarding the historical requests or the historical services;
topic category data of the request; or
language used by the customer.

6. The system of claim 1, wherein the predetermined set of criteria comprises criteria related to at least one of:
availability status of each representative to support the request;
information of a store or department associated with each representative;
job code of each representative;
clock status of each representative;
leave status of each representative;
language preference of each representative; or
a skill profile of each representative.

7. The system of claim 1, wherein:
for each agent device of at least some of the agent devices, a target application is installed on the agent device associated with a corresponding agent.

8. The system of claim 7, wherein in accordance with a determination that the agent device is answered by the corresponding agent:
a script to guide a conversation between the customer and the corresponding agent is dynamically generated at run time for the corresponding agent and displayed on the target application; and
one or more suggested tools are provided to the corresponding agent via the target application to support the request.

9. The system of claim 1, wherein the set of representatives comprises:
an internal set of associates of the entity;
a third party workforce associated with the entity;
an expert associated with the entity; and
a self-service application or chatbot associated with the entity.

10. The system of claim 9, wherein:
the entity is a retailer;
the request is submitted by the customer when the customer is located in a store associated with the retailer; and
associates working in the store are given priority during the selection of the dynamic target group of representatives.

11. The system of claim 10, wherein:
in accordance with a determination that no associate working in the store is available to assist the customer with the request, a call is established between the customer and a remote agent; and
the remote agent is one of: an associate working in other stores of the retailer, an associate employed by the retailer, an agent of a supplier of the retailer, an agent of a vendor of the retailer, a delivery driver for the retailer, an expert on a product or service related to the request, a marketplace seller selling a product or service related to the request, or a self-service application associated with the retailer.

12. A computer-implemented method, comprising:
obtaining, from a customer, a request for service from an entity;
obtaining context information of the request;
selecting, from a set of representatives associated with the entity, a dynamic target group of representatives based on the context information and a predetermined set of criteria; and
routing the request simultaneously to agent devices associated with the dynamic target group of representatives.

13. The computer-implemented method of claim 12, wherein the context information comprises at least one of:
account information of the customer;
information input by the customer regarding the request;
historical requests of the customer;
historical services provided to the customer by the entity;
historical feedbacks of the customer regarding the historical requests or the historical services;
topic category data of the request; or
language used by the customer.

14. The computer-implemented method of claim 12, wherein the predetermined set of criteria comprises criteria related to at least one of:
availability status of each representative to support the request;
information of a store or department associated with each representative;
job code of each representative;
clock status of each representative;
leave status of each representative;
language preference of each representative; or
a skill profile of each representative.

15. The computer-implemented method of claim 12, wherein:
for each agent device of at least some of the agent devices, a target application is installed on the agent device associated with a corresponding agent.

16. The computer-implemented method of claim 15, wherein in accordance with a determination that the agent device is answered by the corresponding agent:
a script to guide a conversation between the customer and the corresponding agent is dynamically generated at run time for the corresponding agent and displayed on the target application; and
one or more suggested tools are provided to the corresponding agent via the target application to support the request.

17. The computer-implemented method of claim 12, wherein the set of representatives comprises:
an internal set of associates of the entity;
a third party workforce associated with the entity;
an expert associated with the entity; and
a self-service application or chatbot associated with the entity.

18. The computer-implemented method of claim 17, wherein:
the entity is a retailer;
the request is submitted by the customer when the customer is located in a store associated with the retailer; and
associates working in the store are given priority during the selection of the dynamic target group of representatives.

19. The computer-implemented method of claim 18, wherein:
in accordance with a determination that no associate working in the store is available to assist the customer with the request, a call is established between the customer and a remote agent; and
the remote agent is one of: an associate working in other stores of the retailer, an associate employed by the retailer, an agent of a supplier of the retailer, an agent of a vendor of the retailer, a delivery driver for the retailer, an expert on a product or service related to the request, a marketplace seller selling a product or service related to the request, or a self-service application associated with the retailer.

20. A non-transitory computer readable medium having instructions stored thereon, wherein the instructions, when executed by at least one processor, cause at least one device to perform operations comprising:
obtaining, from a customer, a request for service from an entity;
obtaining context information of the request;
selecting, from a set of representatives associated with the entity, a dynamic target group of representatives based on the context information and a predetermined set of criteria; and
routing the request simultaneously to agent devices associated with the dynamic target group of representatives.
